(19) United States
(12) Patent Application Publication
(10) Pub. No.: US 2013/0235976 A1
(43) Pub. Date: Sep. 12, 2013

(54) X-RAY SOURCE DEVICE

(71) Applicant: SAMSUNG ELECTRONICS CO., LTD., Suwon-si (KR)

(72) Inventors: Tae-won JEONG, Yongin-si (KR); Yong-chul KIM, Seoul (KR); Do-yoon KIM, Hwaseong-si (KR); Il-hwan KIM, Seoul (KR); Shang-hyeun PARK, Yongin-si (KR)

(73) Assignee: SAMSUNG ELECTRONICS CO., LTD., Suwon-si (KR)

(21) Appl. No.: 13/746,118

(22) Filed: Jan. 21, 2013

(30) Foreign Application Priority Data
Mar. 6, 2012 (KR) 10-2012-0022888

(51) Int. Cl. H01J 35/04; H01J 9/18

(52) U.S. Cl. CPC H01J 35/045; H01J 9/18
USPC 378/121; 445/28

(57) ABSTRACT

An X-ray source device includes a substrate, a cathode electrode on the substrate, an emitter on the cathode electrode, an insulation body around the cathode electrode, a gate electrode on the insulation body, a first secondary electron emission layer at a side wall of the gate electrode and emitting secondary electrons upon collision with an electron beam emitted by the emitter, and an anode electrode separated from the gate electrode.

### CROSS-REFERENCE TO RELATED APPLICATIONS

This application claims priority to Korean Patent Application No. 10-2012-0022888, filed on Mar. 6, 2012, and all the benefits accruing therefrom under 35 U.S.C. §119, the disclosure of which is incorporated herein in its entirety by reference.

### BACKGROUND

1. Field

Provided is an X-ray source device capable of stably emitting electrons by amplifying them.

2. Description of the Related Art

With the constant increase in consumer health awareness, many studies have been performed on various pieces of medical equipment. An X-ray source device is an example of such medical equipment. Carbon nanotube is generally used for an emitter in an X-ray source device since an electron beam can be focused via a high emission current and a relatively simple structure. Also, since an on/off switching speed of an emitter using the carbon nanotube is fast, an X-ray source device including an emitter using the carbon nanotube has been actively researched.

The X-ray source device requires a high current, and a high electric field is needed to emit the high current. However, a high electric field may affect the stability of the electron emission of the carbon nanotube, and a structural stability between an electrode such as a cathode including the carbon nanotube and an electrode such as a gate, inducing a voltage. Since current flows beyond a current density limit in a portion of the carbon nanotube where the electric field is concentrated, the carbon nanotube may be undesirably destructed or detached from a substrate due to the high electric field. Also, as a gate may be detached, the gate may be undesirably attached to the cathode due to the high electric field between the gate and the cathode.

### SUMMARY

Provided is one or more embodiment of an X-ray source device capable of stably emitting electrons by amplifying the electrons.

Additional aspects will be set forth in part in the description which follows and, in part, will be apparent from the description, or may be learned by practice of the presented embodiments.

Provided is an X-ray source device including a substrate, a cathode electrode on the substrate, an emitter on the cathode electrode, an insulation body provided around the cathode electrode, a gate electrode provided on the insulation body, a first secondary electron emission layer provided at a side wall of the gate electrode and emitting secondary electrons upon collision with an electron beam emitted by the emitter, and an anode electrode arranged to be separated from the gate electrode.

The gate electrode may have a mesh structure.

A second secondary electrons emission layer may be further provided between the gate electrode and the insulation body.

The first secondary electron emission layer may include a metal oxide, an inorganic material or a combination thereof.

The first secondary electron emission layer may include SiO₂, MgO, Al₂O₃ or a combination thereof.

An adhesion layer may be further provided between the insulation body and the gate electrode.

The adhesion layer may include a glass material.

The adhesion layer may include glass frit.

The emitter may include a carbon nanotube.

The emitter may be formed by a printing method using paste, a chemical vapor deposition method, an electrophoresis method, a transfer method or a combination thereof.

The gate electrode may include a hole separated from an outer edge of the gate electrode.

A width of a lower surface of the gate electrode may be greater than a width of an upper surface of the insulation body.

A width of the insulation body may decrease from a lower surface of the insulating body to the upper surface of the insulation body.

The insulation body may include a groove, the cathode electrode may be provided in the groove, and the groove may have a reversed trapezoidal cross-sectional shape.

The first secondary electron emission layer may be formed by a chemical vapor deposition method, a sputtering method, a thermal oxidation method, a liquid coating method or a combination thereof.

The first secondary electron emission layer and the second secondary electron emission layer may be integral.

### BRIEF DESCRIPTION OF THE DRAWINGS

These and/or other aspects will become apparent and more readily appreciated from the following description of the embodiments, taken in conjunction with the accompanying drawings of which:

FIG. 1 is a cross-sectional view schematically illustrating an X-ray source device, according to an embodiment of the present invention;

FIG. 2 is a plan view illustrating the X-ray source device of FIG. 1 without an anode electrode, according to an embodiment of the present invention;

FIG. 3 is a graph showing a change in a secondary electron emission coefficient according to incident energy in units of electron volts (eV) in an X-ray source device, according to an embodiment of the present invention;

FIG. 4 is a graph showing a change in anode current in units of amperes (A) according to a gate voltage in units of volts (V) with respect to the existence and absence of a secondary electron emission layer in an X-ray source device, according to an embodiment of the present invention; and

FIG. 5 is a graph of load in units of newtons (N) according to time in units of seconds for showing an adhesion force between a gate electrode and an insulation layer with respect to the existence of absence of a secondary electron emission layer in an X-ray source device, according to an embodiment of the present invention.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity.

It will also be understood that when a layer is referred to as being “on” another layer or substrate, it can be directly on the other layer or substrate, or intervening layers may also be present. Like reference numerals in the drawings denote like elements, and thus their description will be omitted. As used herein, the term “and/or” includes any and all combinations of one or more of the associated listed items.

Expressions such as “at least one of,” when preceding a list of elements, modify the entire list of elements and do not modify the individual elements of the list.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “below,” “lower,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be described in detail with reference to the accompanying drawings.

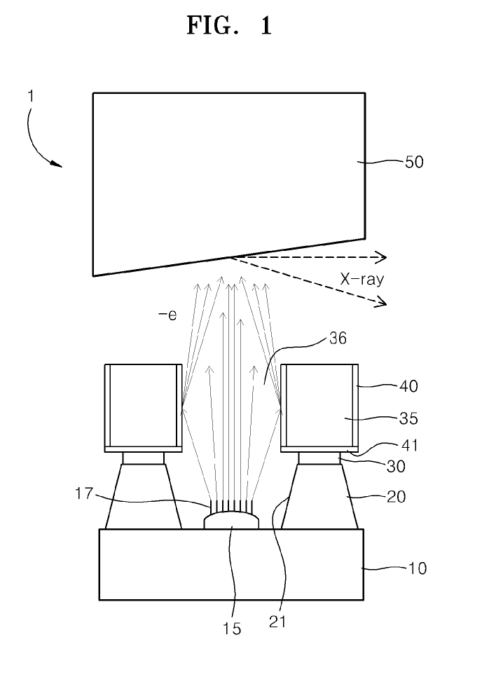

FIG. 1 is a cross-sectional view schematically illustrating an X-ray source device 1, according to an embodiment of the present invention. Referring to FIG. 1, the X-ray source device 1 includes a substrate 10, a cathode electrode 15 provided on the substrate 10, and an emitter 17 provided on the cathode electrode 15 and emitting an electron beam. The substrate 10 may include, for example, invar, stainless steel, glass, etc., but is not limited thereto or thereby. An insulation body 20 may be provided around the cathode electrode 15 to expose the emitter 17 and the cathode electrode 15. A gate electrode 35 may be provided above the insulation body 20 and may expose the emitter 17 and the cathode electrode 15. The insulation body 20 may surround the cathode electrode 15 and have a thickness greater than that of the cathode electrode 35 in a direction perpendicular to the substrate 10. An anode electrode 50 may be provided at a predetermined distance above the gate electrode 35.

As such, the X-ray source device 1 according to the present embodiment may have a triode structure including the cathode electrode 15, the gate electrode 35 and the anode electrode 50. The emitter 17 emits electrons and may have a slender, fine-pointed rod-like shape to facilitate the emission of the electrons. When a voltage is applied to the emitter 17, the electrons may be instantly emitted from the fine-pointed tip of the emitter 17.

The emitter 17 may include, for example, a dispenser cathode material for emitting thermions, a molybdenum (Mo) or carbon (C) based material, such as a compound having at least one Mo or C atom, or zinc oxide (ZnO). The dispenser cathode material may include, for example, porous tungsten (W), barium oxide (BaO), barium strontium oxide (BaSrO), calcium oxide (CaO), aluminum oxide (Al₂O₃), or lanthanum hexaboride (LaB₆). The carbon based material may include, for example, carbon nanotube or diamond-like carbon (“DLC”). In one embodiment, for example, when the emitter 17 includes carbon nanotube, the emitter 17 may be formed by a printing method using paste, a chemical vapor deposition (“CVD”) method, an electrophoresis method, a transfer method or a combination thereof, but is not limited thereto or thereby. Such forming methods may dispose the emitter 17 on the cathode electrode 15. When a voltage is applied to the gate electrode 35, the emitter 17 emits an electron beam. Otherwise, no electron beam is emitted. Accordingly, the gate electrode 35 may function as a switch of an electron beam.

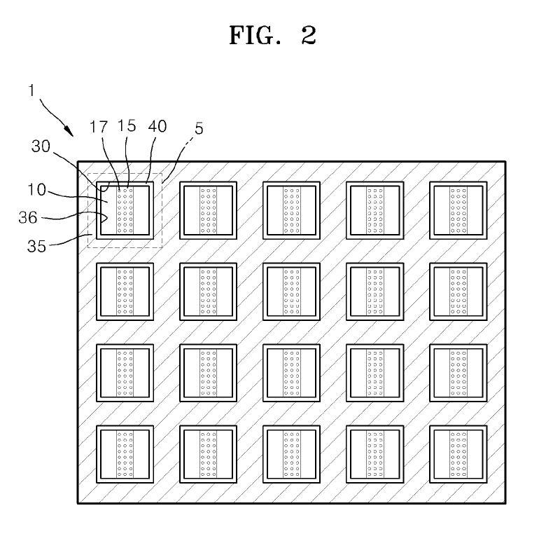

FIG. 2 is a plan view illustrating the X-ray source device 1 without an anode electrode, according to an embodiment of the present invention. Referring to FIG. 2, the X-ray source device 1 may include a plurality of cells 5 that may be arranged in a matrix form. FIG. 1 illustrates one cell outlined by a dotted line.

The gate electrode 35 may be a single, unitary, indivisible member, but is not limited thereto or thereby. The gate electrode 35 may include a hole 36 extended through a thickness thereof, such that the hole 36 may be defined solely by the gate electrode 35, but is not limited thereto or thereby. The hole 36 is separated from an outer edge of the gate electrode 35, and may be in a center of of the gate electrode 35 and/or a center of a cell 5, but is not limited thereto or thereby. The gate electrode 35 may include a plurality of holes 36 arranged in a matrix form, defining a mesh-shaped structure of the gate electrode 35. Although the holes 36 are illustrated to have a rectangular planar shape, the present invention is not limited thereto and the holes 36 may have a variety of shapes such as a circular shape or a polygonal shape in the plan view.

A first secondary electron emission layer 40 may be provided at a side wall of the gate electrode 35. The secondary electron emission layer 40 may induce emission of one or more secondary electrons from the electrons emitted by the emitter 17. The first secondary electron emission layer 40 may include a metal oxide or an inorganic material. In one embodiment, for example, the first secondary electron emission layer 40 may include SiO₂, MgO, Al₂O₃, a combination thereof, etc., but is not limited thereto or thereby. The first secondary electron emission layer 40 may be formed by a CVD method, a sputtering method, a thermal oxidation method or a liquid coating method, but is not limited thereto or thereby.

Primary electrons emitted by the emitter 17 and the secondary electrons emitted by the first secondary electron emission layer 40 are accelerated to collide against the anode electrode 50. Accordingly, an X-ray may be induced and emitted by the anode electrode 50.

The insulation body 20 includes portions around the cathode electrode 15 and grooves 21 aligned with or corresponding to the holes 36 of the gate electrode 35. The insulation body 20 may have, for example, a mesh structure defined by the portions around the cathode electrode 15 and the grooves 21. The cathode electrode 15 may be in the groove 21 of the insulation body 20. When a voltage is applied to the cathode electrode 15 and the gate electrode 35, the insulation body 20 may reduce or effectively prevent an electrical short-circuit between the cathode electrode 15 and the gate electrode 35.

The insulation body 20 may have a cross-sectional shape such that a width of the portions around the cathode electrode 35 gradually decreases in a direction from a lower portion toward an upper portion thereof. In one embodiment, for example, the portions of the insulation body 20 around the cathode electrode 15 may have a trapezoidal cross-sectional shape, and the groove 21 of the insulation body 20 may have a reversed trapezoidal cross-sectional shape. An efficiency of reflecting the electrons emitted by the emitter 17 may be increased according to the shape of the groove 21. An adhesion layer 30 may be provided between the gate electrode 35 and the insulation body 20 to bond the gate electrode 35 and the insulation body 20 to each other.

As described above, the first secondary electron emission layer 40 may be provided at the side wall of the gate electrode 35. The primary electrons emitted by the emitter 17 may be incident on the first secondary electron emission layer 40 to induce emission of one or more secondary electrons. A second secondary electron emission layer 41 may be further provided on a lower surface of the gate electrode 35.

A width of the lower surface of the gate electrode 35 may be larger than that of an upper surface of the insulation body 20. When the second secondary electron emission layer 41 is arranged on the lower surface of the gate electrode 35, a surface of the second secondary electron emission layer 41 may be exposed to the outside or to the emitter 17. Thus, when the second secondary electron emission layer 41 is further arranged on the lower surface of the gate electrode 35, an electron emission efficiency of secondarily amplifying the primary electrons emitted by the emitter 17 in the secondary electrons emission layer 41 may be further improved. The first secondary electron emission layer 40 and the second secondary electron emission layer 41 may be integral to define a single, unitary, indivisible member, but is not limited thereto or thereby.

The adhesion layer 30 may include a glass material, for example, glass frit. When the adhesion layer 30 includes a glass material, an adhesion force between the gate electrode 35 and the insulation body 20 may be small. When the second secondary electron emission layer 41 is further provided between the gate electrode 35 and the insulation body 20, the adhesion force between the gate electrode 35 and the insulation body 20 may be increased. Since the second secondary electron emission layer 41 exhibits a superior adhesion force to glass, the adhesion force between the gate electrode 35 and the insulation body 20 may be increased.

In one embodiment, the gate electrode 35 and the insulation body 20 are combined by using glass frit and then sintered so that the gate electrode 35 and the insulation body 20 may be bonded to each other. The adhesion force may be improved by the second secondary electron emission layer 41. Thus, a high electric field between the gate electrode 35 and the insulation body 20 may reduce or effectively prevent detachment of the gate electrode 35 from the insulation body 20. As such, the second secondary electron emission layer 41 may amplify the secondary electrons and simultaneously improve the adhesion force between the gate electrode 35 and the insulation body 20.

When the X-ray source device 1 according to the present embodiment operates and the primary electrons that are field-emitted by the emitter 17 are incident on the gate electrode 35 coated with the first secondary electron emission layer 40 and the second secondary electron emission layer 41, one or more secondary electron emissions may be induced. The secondary electrons amplified by the first and second secondary electron emission layers 40 and 41 and the primary electrons emitted without passing through the first and second secondary electron emission layers 40 and 41 are accelerated and collide against the anode 50 so that an X-ray may be induced.

As described above, the first and second secondary electron emission layers 40 and 41 may amplify the primary electrons.

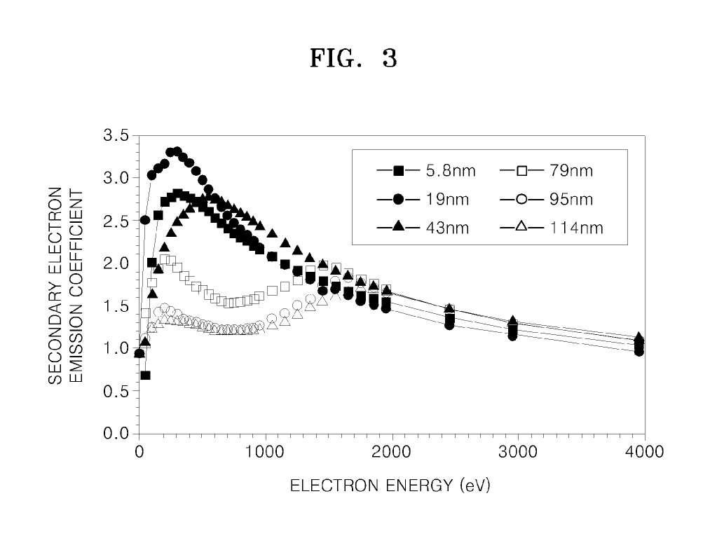

FIG. 3 is a graph showing a change in a secondary electron emission coefficient δ according to electron energy in units of electron volts (eV) incident on the first and second secondary electron emission layers 40 and 41 when the first and second secondary electron emission layers 40 and 41 include SiO₂, according to a thickness of each secondary electron emission layer in units of nanometers (nm). The secondary electron emission coefficient δ indicates a ratio of the number of emitted secondary electrons to the number of incident primary electrons.

Referring to FIG. 3, when the thickness of an SiO₂ secondary electron emission layer is 19 nm, the secondary election emission coefficient at an incident electron energy of 100-500 eV may be 3 or higher. In one embodiment, for example, when one electron emitted by the emitter 17 including carbon nanotube at a gate voltage of 100-500 V is incident on a secondary electron emission layer, three or more secondary electrons may be emitted. According to the graph of FIG. 3, the secondary electron emission coefficient may vary with the thickness of a secondary electron emission layer. Referring to FIG. 3, when a secondary electron emission layer has a thickness greater than 0 and less than or equal to 80 nm, a secondary electron emission efficiency may be improved. In this case, the secondary electron emission coefficient may be greater than or equal to 2.

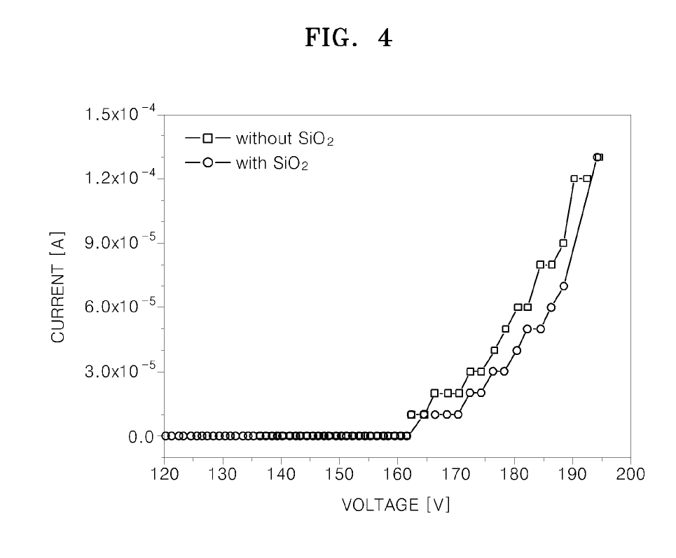

FIG. 4 is a graph showing a change in a current in units of amperes (A) at an anode according to a drive voltage in units of volts (V), in a comparative example (without SiO₂) where an X-ray source device does not include a secondary electron emission layer, and an embodiment of the present invention (with SiO₂) where an X-ray source device does include a secondary electron emission layer. The first and second secondary electron emission layers 40 and 41 as a coating including SiO₂ at a thickness of 20 nm are used as the X-ray source device according to the present embodiment (with SiO₂).

Referring to FIG. 4, a drive voltage for the X-ray source with the first and second secondary electron emission layers 40 and 41 (with SiO₂) is lower than that for the X-ray source without the first and second secondary electron emission layers 40 and 41(without SiO₂). Since the drive voltage is relatively low, damaging of the emitter 17 during driving of the X-ray source device 1 may be reduced. As such, current may be increased and the drive voltage may be reduced by using the amplification of secondary electrons. Thus, an X-ray source device using field emission of a relatively stable emitter may be manufactured.

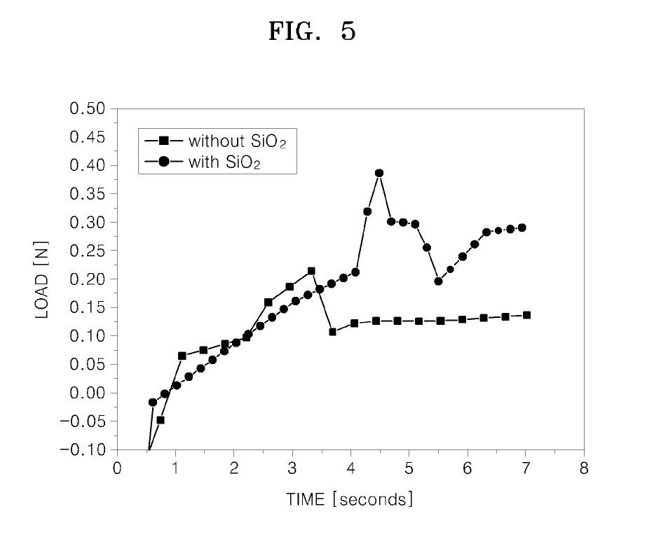

FIG. 5 is a graph showing results of measuring an adhesion force in units of newtons (N) through a peel test to separate two layers, that is, the gate electrode 35 and the insulation body 20, when a gate electrode coated with SiO₂ (with SiO₂) or a gate electrode not coated with SiO₂ (without SiO₂) is attached to a substrate by using glass frit. In view of the maximum load value, an adhesion force of the gate electrode without SiO₂ is lower than that of the gate electrode coated with SiO₂. As such, when a gate electrode is coated with SiO₂, structural stability between the gate electrode 35 and the cathode electrode 15 may be improved due to increased adhesion force between the gate electrode 35 and the insulation layer 20.

As described above, an X-ray source device according to one or more embodiment of the present invention includes a secondary electron emission layer on a surface of a gate electrode so that a drive voltage of the gate electrode may be decreased and current flowing through an anode may be increased. Since the drive voltage of the gate electrode is low, damaging of an emitter due to a high drive voltage may be reduced and unstable field emission due to a damaged emitter may be reduced.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An X-ray source device comprising:
a substrate;
a cathode electrode on the substrate;
an electron beam emitter on the cathode electrode;
an insulation body around the cathode electrode;
a gate electrode on the insulation body;
a first secondary electron emission layer on a side wall of the gate electrode, wherein the first secondary electron emission layer emits secondary electrons upon collision with an electron beam emitted by the electron beam emitter; and
an anode electrode separated from the gate electrode.

2. The X-ray source device of claim 1, wherein the gate electrode has a mesh structure.

3. The X-ray source device of claim 1, further comprising a second secondary electron emission layer between the gate electrode and the insulation body.

4. The X-ray source device of claim 1, wherein the first secondary electron emission layer comprises a metal oxide, an inorganic material or a combination thereof.

5. The X-ray source device of claim 4, wherein the first secondary electron emission layer comprises SiO₂, MgO, Al₂O₃ and a combination thereof.

6. The X-ray source device of claim 1, further comprising an adhesion layer between the insulation body and the gate electrode.

7. The X-ray source device of claim 6, wherein the adhesion layer comprises a glass material.

8. The X-ray source device of claim 7, wherein the adhesion layer comprises glass frit.

9. The X-ray source device of claim 1, wherein the electron beam emitter comprises a carbon nanotube.

10. The X-ray source device of claim 9, wherein the electron beam emitter on the cathode electrode is formed by a printing method using paste, a chemical vapor deposition method, an electrophoresis method, a transfer method or a combination thereof.

11. The X-ray source device of claim 1, wherein the gate electrode comprises a hole separated from an outer edge of the gate electrode.

12. The X-ray source device of claim 1, wherein a width of a lower surface of the gate electrode is greater than a width of an upper surface of the insulation body.

13. The X-ray source device of claim 12, wherein a width of the insulation body decreases from a lower surface of the insulation body toward the upper surface of the insulation body.

14. The X-ray source device of claim 1, wherein
the insulation body comprises a groove,
the cathode electrode is in the groove of the insulation body, and
a width of the groove increases from a lower surface of the insulation body toward an upper surface of the insulation body.

15. The X-ray source device of claim 1, wherein the first secondary electron emission layer on the side wall of the gate electrode is formed by a chemical vapor deposition method, a sputtering method, a thermal oxidation method, a liquid coating method or a combination thereof.

16. The X-ray source device of claim 3, wherein the first secondary electron emission layer and the second secondary electron emission layer are integral.

17. An X-ray source device comprising:
a base substrate;
an emission structure on the base substrate and comprising a hole which exposes the base substrate;
a cathode electrode on the base substrate and in the hole;
an electron beam emitter on the cathode electrode; and
an anode electrode separated from the gate electrode.
wherein the emission structure comprises:
a gate electrode; and
a first secondary electron emission layer on a side wall of the gate electrode at the hole of the emission structure, wherein the first secondary electron emission layer emits secondary electrons upon collision with an electron beam emitted by the electron beam emitter.

18. The X-ray source device of claim 17, wherein the emission structure further comprises a second secondary electron emission layer on a lower surface of the gate electrode and exposed to the electron beam emitter.

19. The X-ray source device of claim 18, wherein the emission structure further comprises an insulating body and an adhesion layer between the second secondary electron emission layer and the base substrate.

20. A method of forming an X-ray source device, the method comprising:
providing a cathode electrode on a substrate,
providing an electron beam emitter on the cathode electrode;
providing an emission structure on the substrate, the emission structure exposing the cathode electrode and the electron beam emitter; and
providing an anode electrode separated from the emission structure,
wherein the emission structure comprises:
a gate electrode; and
a first secondary electron emission layer on a side wall of the gate electrode, wherein the first secondary electron emission layer is exposed to the electron beam emitter and emits secondary electrons upon collision with an electron beam emitted by the electron beam emitter.
